(19) United States
(12) Patent Application Publication
(10) Pub. No.: US 2025/0294099 A1
(43) Pub. Date: Sep. 18, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YUMI IKARASHI, Kanagawa (JP)

(21) Appl. No.: 19/061,845

(22) Filed: Feb. 24, 2025

(30) Foreign Application Priority Data
Mar. 14, 2024 (JP) 2024-039644

(51) Int. Cl. H04N 1/00; G06F 3/12

(52) U.S. Cl. CPC H04N 1/00037; G06F 3/121; G06F 3/1251; H04N 1/00015; H04N 1/00034; H04N 1/00045; H04N 1/00087

(57) ABSTRACT

An image forming apparatus detects a plurality of detection marks of different colors formed on a roll sheet based on a measurement result obtained by reading the roll sheet being conveyed, and then selects, from among the plurality of detection marks, a detection mark to be used for specifying a position of an image to be printed on the roll sheet based on a measurement value of each of the plurality of detection marks.

### BACKGROUND

### Field of the Disclosure

The present disclosure relates to specifying positions on a recording medium.

### Description of the Related Art

To specify the position of an image to be printed, there is a typical technique in which a dedicated detection mark is printed with the image and the printed detection mark is detected to specify the position of the printed image. Japanese Patent Application Laid-Open No. 2010-41673 discusses a method for detecting the position of a mark (area detection mark) for detecting the area of a handwritten image from a handwritten document sheet including the area detection mark, based on luminance information and color difference information obtained by scanning the area including the area detection mark. In the method discussed in Japanese Patent Application Laid-Open No. 2010-41673, an area detection mark cannot be detected unless a luminance difference or a color difference between the base color of a sheet and the area detection mark is greater than or equal to a predetermined amount.

### SUMMARY

According to an aspect of the present disclosure, an information processing apparatus includes at least one memory that stores a set of instructions, and at least one processor that executes the instructions causing the information processing apparatus to perform operations including detecting a plurality of marks of different colors formed on a recording medium based on a measurement result obtained by reading the recording medium being conveyed, and selecting, from among the plurality of marks, a mark to be used for specifying a position of an image to be printed on the recording medium based on a measurement value of each of the plurality of marks.

Further features of the present disclosure will become apparent from the following description of exemplary embodiments with reference to the attached drawings.

### BRIEF DESCRIPTION OF THE DRAWINGS

FIG. 1 is a diagram illustrating an example of an overall configuration of an image forming system.

FIGS. 2A and 2B are each a block diagram illustrating an example configuration of an image forming apparatus.

FIG. 3 is a flowchart illustrating a mark selection process.

FIGS. 4A, 4B, and 4C are diagrams illustrating examples of detection marks.

FIGS. 5A and 5B are diagrams illustrating detection of a detection mark.

FIG. 6 is a flowchart illustrating a mark determination process.

FIG. 7 is a flowchart illustrating a mark determination process.

FIG. 8 is a flowchart illustrating a mark determination process.

### DESCRIPTION OF THE EMBODIMENTS

The present disclosure is directed to accurately detecting marks formed on a recording medium.

Hereinafter, an exemplary embodiment of the present disclosure will be described with reference to the accompanying drawings.

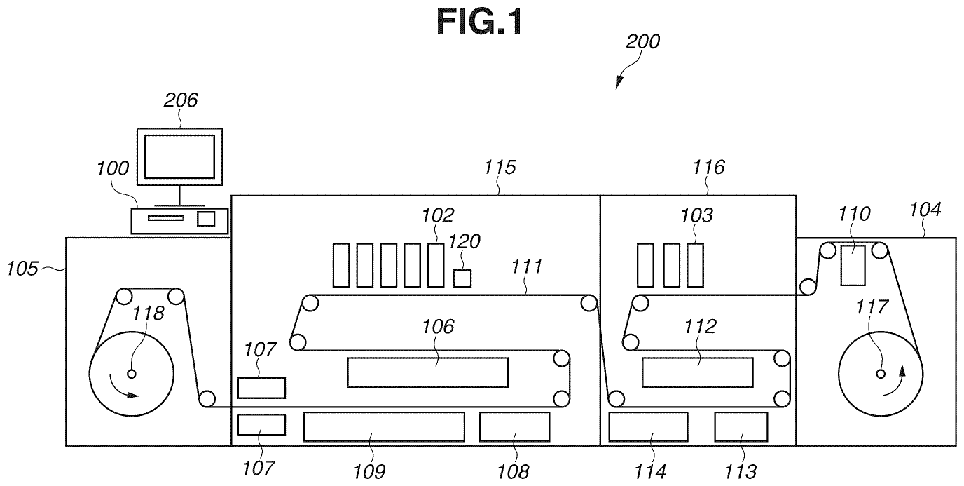

FIG. 1 illustrates an example of an overall configuration of an image forming system 200 according to the present exemplary embodiment. The image forming system 200 is configured to form a print image on a roll sheet 111. The roll sheet 111 is a continuous sheet and is an example of a recording medium. The image forming system 200 includes an image forming apparatus 100 that controls the entire system, a sheet feeding device 104, a first printing apparatus 115 that prints a print image, a second printing apparatus 116 that prints position detection marks (hereinafter, may be referred to as “detection marks”) before a print image is printed, and a sheet discharge device 105. The image forming apparatus 100 includes an operation display unit 206.

The operation display unit 206 is, for example, a user interface (UI) operation panel that displays a UI and receives various input operations from a user. The printing method for the first printing apparatus 115 and the second printing apparatus 116 may be an electrophotographic method or an inkjet method.

The sheet feeding device 104 feeds the roll sheet 111 to the second printing apparatus 116 and the first printing apparatus 115. Before printing is started, the roll sheet 111 wound on a paper tube in the sheet feeding device 104 is set through to the sheet discharge device 105. In setting the roll sheet 111, the leading edge of the roll sheet 111 is passed over a skew correction device 110. The sheet feeding device 104 rotates the paper tube of the roll sheet 111 about a rotation shaft 117 to convey the roll sheet 111 wound on the paper tube toward the second printing apparatus 116 at a constant speed via a plurality of rollers, such as a conveyance roller and a sheet feeding roller. The roll sheet 111 conveyed to the second printing apparatus 116 is further conveyed to the first printing apparatus 115.

The sheet discharge device 105 winds the roll sheet 111 conveyed from the first printing apparatus 115 into a roll onto a paper tube. The sheet discharge device 105 winds the conveyed roll sheet 111 as a product onto the paper tube being rotated about a rotation shaft 118 at a constant speed via a plurality of rollers, such as a conveyance roller and a sheet discharge roller.

The second printing apparatus 116 prints position detection marks on the roll sheet 111 conveyed from the sheet feeding device 104. The second printing apparatus 116 includes second recording units 103 that perform printing with special color inks (e.g., white ink) other than basic color inks (e.g., cyan, magenta, yellow, and black (CMYK) inks). In the present exemplary embodiment, the special color ink includes a plurality of inks having different colors.

The second printing apparatus 116 forms, on the roll sheet 111, detection marks to be used for detecting positions including, for example, a printing position, a printing start position, and an image analysis position, of a print image to be printed by the first printing apparatus 115 at positions not overlapping the print image, using the second recording units 103. Here, a plurality of detection marks corresponding to a plurality of inks to be used in the second recording units 103 are formed at predetermined positions on the roll sheet 111. The roll sheet 111 on which the second recording units 103 have performed printing is conveyed to the first printing apparatus 115 via a drying device 112 and cooling devices 113 and 114.

The first printing apparatus 115 prints a print image on the roll sheet 111 conveyed from the second printing apparatus 116. The first printing apparatus 115 includes first recording units 102 that perform printing with the basic color inks. The roll sheet 111 conveyed from the second printing apparatus 116 initially passes through a sensor 120 for detecting detection marks on the roll sheet 111. Thereafter, the first printing apparatus 115 forms a print image on the roll sheet 111 using the first recording units 102. The printing position of the print image is specified using a detection mark detected by the sensor 120.

The roll sheet 111 on which the first recording units 102 have performed printing is conveyed to pass through connected scanner devices 107 via a drying device 106 and cooling devices 108 and 109. The roll sheet 111 that has passed through the connected scanner devices 107 is further conveyed to the sheet discharge device 105.

In response to receiving a print start operation for an image forming job (hereinafter referred to as a job) issued through the operation display unit 206, the image forming apparatus 100 controls the devices of the image forming system 200 to process the job. The image forming apparatus 100 is an example of an information processing apparatus.

The image forming apparatus 100 may read a printed product with a scanner device (not illustrated) and inspect for any defects on the printed product. For example, the image forming apparatus 100 checks whether printing is performed without any failures in ejection from ink ejection nozzles. The image forming apparatus 100 stops the process of a job when an ejection failure occurs. Inspection methods include printing a detection pattern and reading the detection pattern with a scanner device, reading a print image with a camera or a scanner device, and monitoring the ejection status of ink ejection nozzles. The sensor 120 may also have the functions of the foregoing scanner devices.

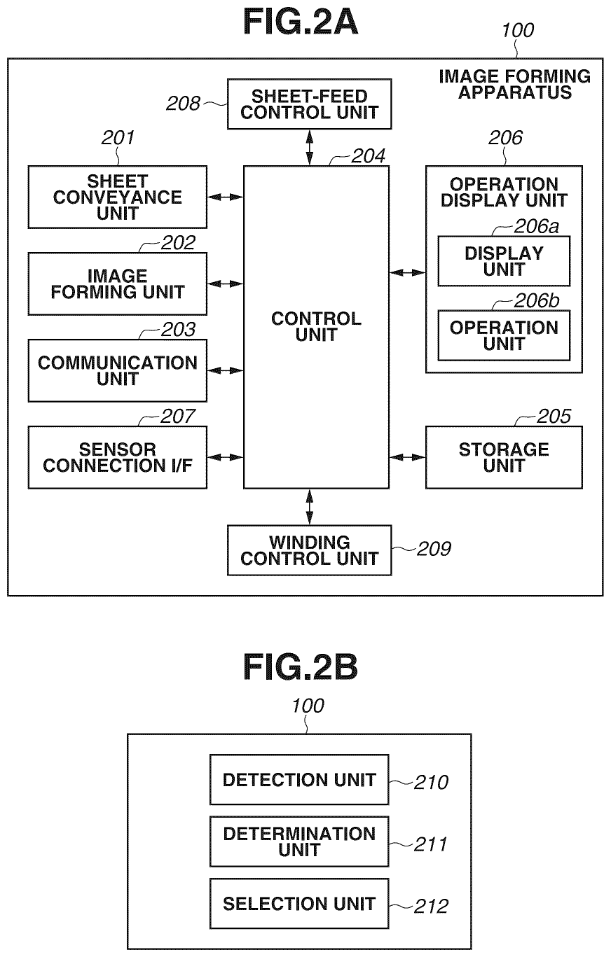

Next, an example of a configuration of the image forming apparatus 100 will be described with reference to FIGS. 2A and 2B.

FIG. 2A illustrates a hardware configuration of the image forming apparatus 100. The image forming apparatus 100 includes a sheet conveyance unit 201, an image forming unit 202, a communication unit 203, a control unit 204, a storage unit 205, the operation display unit 206, a sensor connection I/F 207, a sheet-feed control unit 208, and a winding control unit 209.

The sheet conveyance unit 201 controls a conveyance mechanism inside the image forming system 200 under the control of the control unit 204. The sheet conveyance unit 201 conveys the roll sheet 111 supplied from the sheet feeding device 104 to the second printing apparatus 116, the first printing apparatus 115, and the sheet discharge device 105 at a set printing speed with, for example, a plurality of rollers.

The image forming unit 202 forms, based on a job, a print image on the roll sheet 111 conveyed from the sheet feeding device 104 via the second printing apparatus 116 using the first printing apparatus 115, under the control of the control unit 204. The data on the job may be received from an external apparatus via the communication unit 203. The control unit 204 performs control to insert a plurality of detection marks of different colors into margins on the roll sheet 111 so that the detection marks align with the top position of each page of the job. The image forming unit 202 forms a plurality of detection marks of different colors on the roll sheet 111 conveyed from the sheet feeding device 104 using the second printing apparatus 116, under the control of the control unit 204.

The communication unit 203 includes a communication control card, such as a local area network (LAN) card. The control unit 204 transmits and receives various types of data to and from an external apparatus (e.g., a personal computer) connected to a communication network, such as LAN or a wide area network (WAN), via the communication unit 203. The external apparatus creates data on a job in response to a user's instruction. The external apparatus transmits the created data on the job and setting information, such as a print setting and a delivery volume setting of the job, to the image forming apparatus 100 via the communication network.

The control unit 204 includes a central processing unit (CPU) and a random access memory (RAM). The control unit 204 controls the overall operation of the image forming apparatus 100. The CPU of the control unit 204 reads various programs, such as a system program and a processing program, stored in the storage unit 205, loads the programs into the RAM, and executes various processes in accordance with the loaded programs. The control unit 204 can execute a job in accordance with a user's instruction.

The storage unit 205 includes a nonvolatile semiconductor memory (commonly known as a flash memory) and a hard disk drive (HDD). The storage unit 205 stores various programs including a system program and a processing program that are executed in the control unit 204, as well as various types of data to be used for executing these programs.

The operation display unit 206 includes a liquid crystal display (LCD) with, for example, a touch panel, and is provided with a display unit 206a and an operation unit 206b. The display unit 206a displays various types of information on a display screen in accordance with display control signals input from the control unit 204. The operation unit 206b includes various operation keys, such as a numeric keypad and a start key, receives various input operations from a user, and outputs operation signals to the control unit 204.

The operation display unit 206 is used for setting a job, for example, in execution of the job. The control unit 204 displays, on the display unit 206a, a UI for selecting items, such as the type of sheet to be used, a printing speed, the number of sheets to be printed, the number of copies to be printed, a print length, a print weight, and a printing diameter, and sets the items in accordance with the input operation received by the operation unit 206b.

The sensor connection I/F 207 is used for connecting to the sensor 120. The sensor 120 continuously reads and measures the luminance on the roll sheet 111 along the conveyance direction before the first printing apparatus 115 forms a print image. The control unit 204 obtains the luminance measurement values measured by the sensor 120 in a time series via the sensor connection I/F 207 and stores the measurement values in the storage unit 205. Thus, the storage unit 205 stores results of measurements of the luminance on the roll sheet 111 relative to the conveyance distances. While a sensor 120 is used in the present exemplary embodiment, a scanner device may be used, and the present disclosure is not limited thereto. For the use of the scanner device, the storage unit 205 stores measurement results obtained from scanned image data.

Next, FIG. 2B illustrates a functional configuration of the image forming apparatus 100. The CPU of the control unit 204 reads the programs stored in the storage unit 205, loads the programs into the RAM, and executes the programs, thus realizing the functions of a detection unit 210, a determination unit 211, and a selection unit 212.

The detection unit 210 reads results of measurements of the luminance on the roll sheet 111 relative to the conveyance distances from the storage unit 205, and detects detection marks based on the positions at which changes from the luminance of a sheet base are observed. In the present exemplary embodiment, a plurality of detection marks having different colors are formed on the roll sheet 111, and thus, the plurality of detection marks having different colors are detected.

The determination unit 211 determines whether the plurality of detection marks detected by the detection unit 210 are valid or invalid. For example, a detection mark that satisfies conditions for erroneous detection is determined to be invalid.

The selection unit 212 excludes the detection mark(s) that has/have been determined to be invalid by the determination unit 211 from the plurality of detection marks detected by the detection unit 210, and selects a detection mark to be used for specifying the printing position of a print image. In the present exemplary embodiment, the selection unit 212 selects the detection mark with the largest difference in luminance (luminance difference) from a sheet base. The luminance of the sheet base is an example of the luminance of a recording medium itself. The control unit 204 sets the selected detection mark to the detection mark to be used for specifying a printing position, and controls the image forming unit 202.

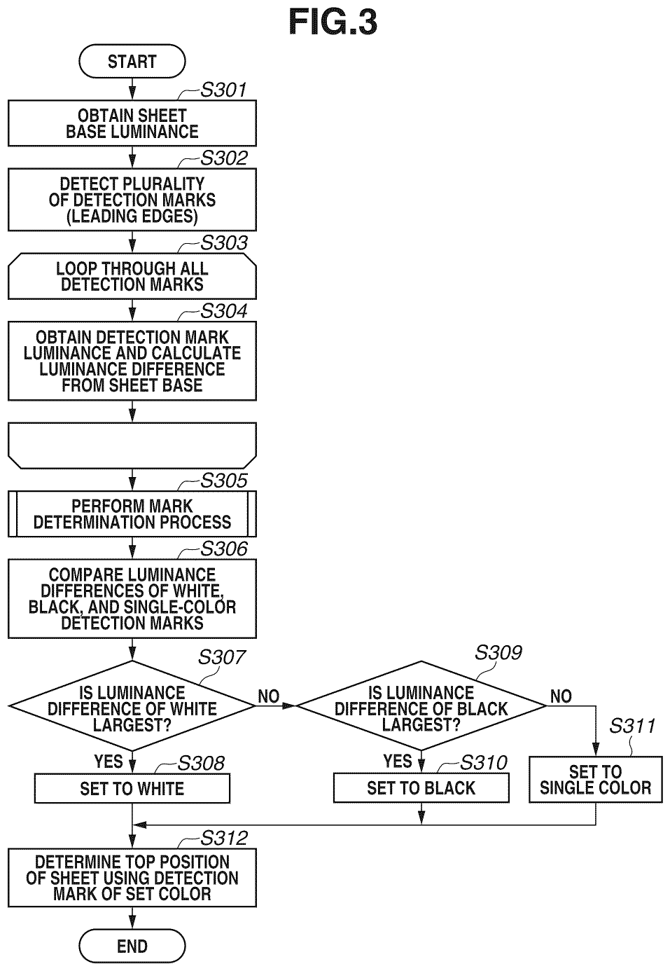

FIG. 3 illustrates a mark selection process for selecting a detection mark using results of measurements of the luminance on the roll sheet 111 relative to conveyance distances. The control unit 204 makes a setting so that the top position of a page is specified using the selected detection mark, and controls the printing position of a print image that is to be printed by the first printing apparatus 115. The process of the flowchart in FIG. 3 is realized by the CPU of the control unit 204 reading various programs stored in the storage unit 205, loading the programs into the RAM, and executing the programs. In the present exemplary embodiment, the roll sheet 111 is described as an example of a recording medium, so that the medium to be measured is pre-set at the position of the sensor 120. However, the present exemplary embodiment is applicable to not only the roll sheet 111 but also cut sheets, which can be conveyed one by one or manually inserted.

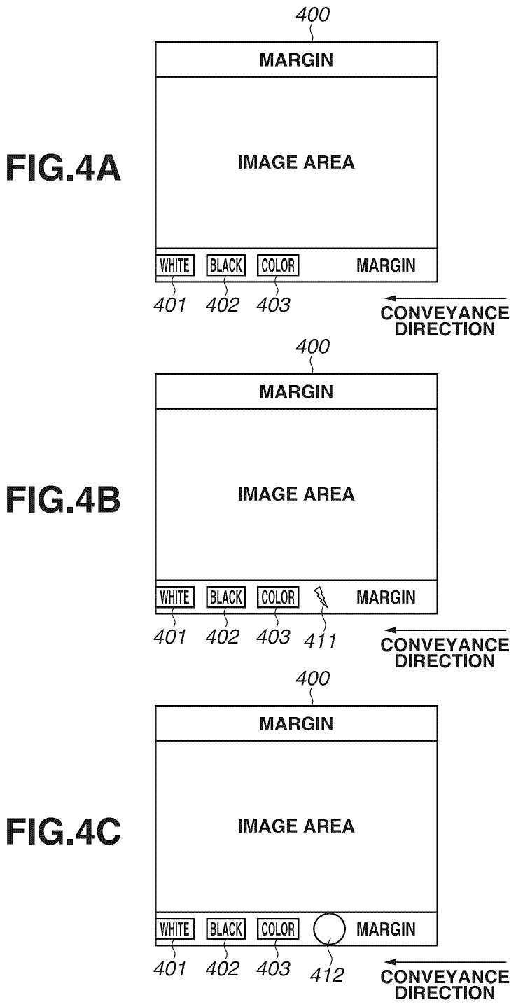

FIGS. 4A, 4B, and 4C each illustrate an example of detection marks. In the present exemplary embodiment, detection marks are inserted to specify the top position of a page, but the use case of inserting the detection mark is not limited thereto. The present exemplary embodiment is applicable to various cases of detecting positions, such as a printing position, a printing start position, and an image analysis position of a print image on a recording medium.

An area 400 of FIG. 4A represents one page of the roll sheet 111, including an area for printing a print image (such an area is also referred to as an image area) and margins at both ends of the image area. In the margins, three detection marks of different colors (white, black, and a single color) are printed in the order of white, black, and the single color in the conveyance direction. The single color is any of yellow (Y), magenta (M), and cyan (C). The distance from the top position of the image area to each detection mark is fixed, so that the top position of the page is specified using a selected detection mark and the conveyance distance.

In the example of FIG. 4A, a white detection mark 401 is printed to align with the top position of the image area. A black detection mark 402 is printed at a predetermined distance from the white detection mark 401 in the conveyance direction. A single-color detection mark 403 is printed at a predetermined distance from the black detection mark 402 in the conveyance direction. The combination of the colors of the detection marks is not limited to that in the present exemplary embodiment. The colors may be changed according to sheet properties, and the number of colors may be increased or decreased.

In the present exemplary embodiment, the size of the respective detection marks 401, 402, and 403 is set to 3 millimeters (mm) in vertical and 3 mm in horizontal, but may be larger or smaller than this. The detection marks 401, 402, and 403 are sequentially measured for the luminance by the single sensor 120. Alternatively, with the detection marks 401, 402, and 403 arranged in a direction intersecting the conveyance direction, the sensor 120 may simultaneously measure the luminance of each detection mark.

The flowchart in FIG. 3 will now be described.

The flowchart in FIG. 3 is started in a case where a job is executed in response to an instruction issued through the operation display unit 206. When the job is executed, the conveyance of the pre-set roll sheet 111 is started, and a plurality of detection marks of different colors are printed in a margin on the roll sheet 111 to align with the top position of each page of the job. The luminance on the roll sheet 111 on which the detection marks have been printed is measured by the sensor 120, and results of the measurements of the luminance on the roll sheet 111 relative to conveyance distances are stored in the storage unit 205.

Initially in step S301, the detection unit 210 reads, from the storage unit 205, the results of measurements of the luminance on the roll sheet 111 relative to the conveyance distances performed by the sensor 120, and obtains the luminance of the sheet base.

Subsequently, in step S302, the detection unit 210 detects the plurality of detection marks from the measurement results read in step S301, based on the positions at which changes from the luminance of the sheet base are observed.

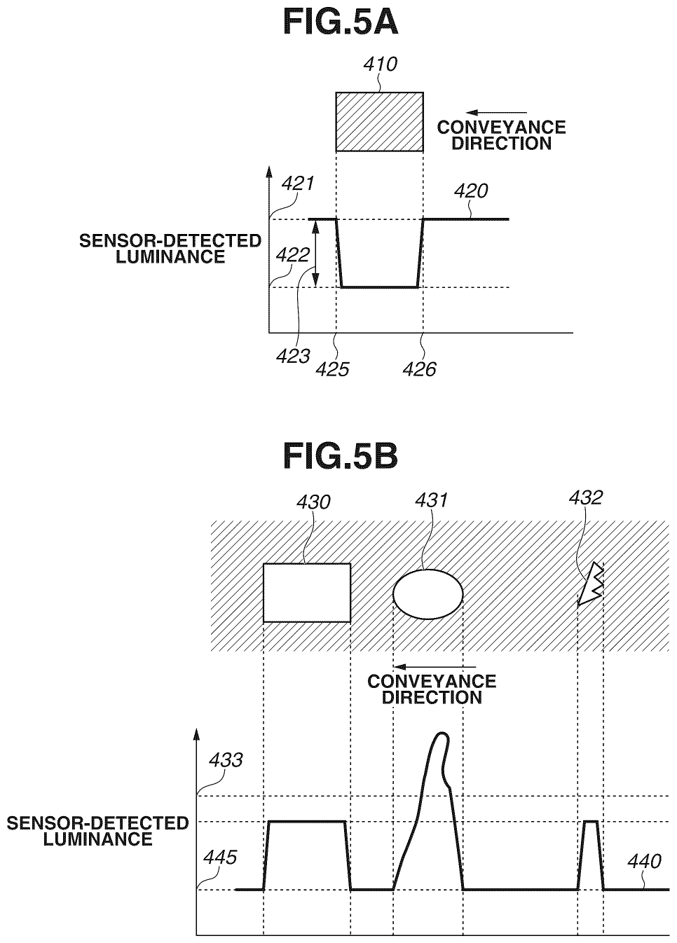

Detection of the detection marks will now be described with reference to FIGS. 5A and 5B. In the graph of FIG. 5A, the horizontal axis represents the conveyance distance (position in the conveyance direction), and the vertical axis represents the luminance measured by the sensor 120. The range of luminance is, for example, 0 to 255. A lower luminance indicates a darker color, and a higher luminance indicates a lighter color. A polyline 420 represents the luminance relative to the conveyance distance. Luminance 421 represents the luminance of a sheet base. The detection unit 210 detects a detection mark 410 based on a leading edge 425 which is a position at which a change from the luminance 421 of the sheet base is observed in the polyline 420. Since the plurality of detection marks (here, three detection marks 401, 402, and 403, in white, black, and the single color, respectively) are formed on the roll sheet 111, the detection unit 210 detects the plurality of detection marks.

In step S303, the detection unit 210 repeatedly executes the operation in step S304 (next described) for the number of the detection marks detected in step S302.

In step S304, the detection unit 210 sets the first detected detection mark to a target and calculates the luminance difference between the luminance of the detection mark set to the target and the luminance of the sheet base obtained in step S301. More specifically, the detection unit 210 calculates the difference between luminance 422 of the detection mark 410 and the luminance 421 of the sheet base as a luminance difference 423. Subsequently, the detection unit 210 sequentially subjects the second and third detected detection marks to the operation in step S304, thus calculating the luminance differences for all the detection marks detected in step S302. The processing then proceeds to step S305.

In the present exemplary embodiment, the three detection marks 401, 402, and 403 in white, black, and the single color, respectively, are printed. However, due to erroneous detections or other reasons, more than three detection marks may be detected. In such a case, an error may occur in the correspondence between the luminance differences calculated in step S304 and the detection marks 401, 402, and 403. Additionally, even the three detection marks 401, 402, and 403 in white, black, and the single color, respectively, may be unsuitable for use in specifying the image position depending on the material or base color of the roll sheet 111.

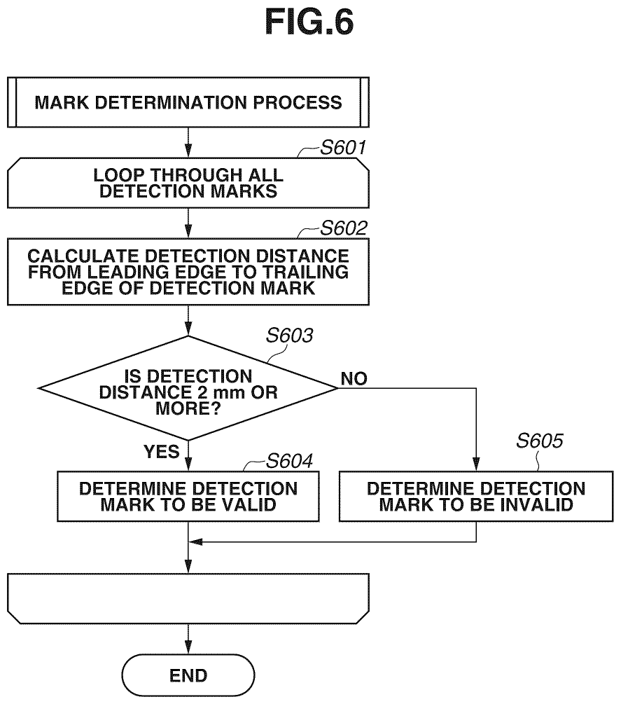

Thus, in step S305, the determination unit 211 performs a mark determination process of determining whether each of the plurality of detection marks detected in step S302 is valid or invalid. Details of the operation executed in this step will be described below with reference to FIGS. 6 to 8. The determination unit 211 excludes the detection mark(s) that has/have been determined to be invalid in step S305 from the plurality of detection marks detected in step S302, thus specifying the three detection marks 401, 402, and 403 in white, black, and the single color, respectively. If any of the three detection marks 401, 402, and 403 in white, black, and the single color, respectively, are determined to be invalid in step S305, only the remaining detection marks are to be subjected to the operations in step S306 and the subsequent steps.

In step S306, the selection unit 212 compares the luminance differences of the three detection marks 401, 402, and 403 in white, black, and the single color, respectively. In the subsequent steps S307 to S311, the selection unit 212 performs an operation for selecting the detection mark with the largest luminance difference. If the luminance of the sheet base is 100 and the luminance of the white detection mark 401 is 100, the luminance difference is 0. If the luminance of the sheet base is 100 and the luminance of the black detection mark 402 is 70, the luminance difference is 30. If the luminance of the sheet base is 100 and the luminance of the single-color detection mark 403 is 90, the luminance difference is 10.

In step S307, if the selection unit 212 determines that the luminance difference of the white detection mark 401 is the largest (YES in step S307), the processing proceeds to step S308; otherwise (NO in step S307), the processing proceeds to step S309.

In step S308, the selection unit 212 sets the white detection mark 401 to the detection mark to be used for specifying the top position of the page.

In step S309, if the selection unit 212 determines that the luminance difference of the black detection mark 402 is the largest (YES in step S309), the processing proceeds to step S311; otherwise (NO in step S309), the selection unit 212 determines that the luminance difference of the single-color detection mark 403 is the largest, and the processing proceeds to step S311.

In step S310, the selection unit 212 sets the black detection mark 402 to the detection mark to be used for specifying the top position of the page.

In step S311, the selection unit 212 sets the single-color detection mark 403 to the detection mark to be used for specifying the top position of the page.

Here, the luminance difference of the black detection mark 402 calculated in step S304 is the largest, the black detection mark 402 is set to the detection mark to be used for specifying the top position of the page.

In step S312, the control unit 204 controls the image forming unit 202 to specify the top position of the page using the detection mark of the color set in any one of steps S308, S310, and S311, and performs printing of a print image. The series of operations of the flowchart is then ended.

Next, the mark determination process of determining whether the respective detection marks are valid or invalid, which is executed in step S305 before the process of comparing the luminance differences, will now be described with reference to the flowcharts of FIGS. 6 to 8. Any of the processes illustrated in the flowcharts of FIGS. 6 to 8 may be selectively executed or all of the processes may be executed, depending on the usage environment of the image forming system 200.

The mark determination process illustrated in FIG. 6 is a process of determining validity or invalidity of detected detection marks based on a detection distance which is the distance from the leading edge to the trailing edge of the respective detected detection marks. In the example of FIG. 5A, the detection distance of the detection mark 410 is the distance from the leading edge 425, at which a change from the luminance 421 of the sheet base is observed, to a trailing edge 426, at which the luminance 421 of the sheet base is observed again, in the polyline 420.

FIG. 4B illustrates a state with dirt 411 next to the single-color detection mark 403 in FIG. 4A. The dirt 411 is an example of an object that causes erroneous detection as a detection mark. The dirt 411 is assumed to be contaminants, such as foreign matter, or scratches on a roll sheet, but is not limited thereto. The dirt 411 is presumably smaller than the size of a detection mark. Thus, in the mark determination process illustrated in FIG. 6, among the plurality of objects each detected as a detection mark by the detection unit 210, the object(s) smaller than a predetermined size of a detection mark, such as the dirt 411, is/are excluded from the targets from which the detection mark is to be selected by the selection unit 212.

FIG. 5B illustrates results of luminance measurements of objects that cause erroneous detection and a detection mark. In the graph of FIG. 5B, the horizontal axis represents the conveyance distance, and the vertical axis represents the luminance measured by the sensor 120. Luminance 445 represents the luminance of a sheet base. While FIG. 5A illustrates a case where the luminance of the sheet base is higher than the luminance of the detection mark 410, FIG. 5B illustrates a case where the luminance 445 of the sheet base is lower than the luminance of the respective objects detected as detection marks. A polyline 440 represents the luminance relative to the conveyance distance. Here, in the polyline 440, a change from the luminance 445 of the sheet base is observed at the position of dirt 432, so that the detection unit 210 detects the dirt 432. However, the detection distance of the dirt 432 is shorter than the detection distance of a detection mark 430. Thus, in the mark determination process illustrated in FIG. 6, any objects with the detection distance shorter than that of the detection mark 430, such as the dirt 432, are determined to be invalid.

In step S601, the determination unit 211 repeatedly executes the operations in steps S602 to S605 for the number of detection marks detected in step S302. In the example of FIG. 4B, the three detection marks 401, 402, and 403 in white, black, and the single color, respectively, and the dirt 411 are to be subjected to the operations in step S602 to step S605.

In step S602, the determination unit 211 sets the first detected detection mark to a target and calculates the detection distance of the detection mark set to the target.

In step S603, the determination unit 211 determines whether the detection distance calculated in step S602 is greater than or equal to a threshold (e.g., 2 mm). If the detection distance is greater than or equal to the threshold (YES in step S603), the processing proceeds to step S604. If the detection distance is less than the threshold (NO in step S603), the processing proceeds to step S605. Here, the threshold for the detection distance is set to 2 mm, but it can be appropriately adjusted based on the measurement accuracy of the sensor 120 and the sizes of the margins.

In step S604, the determination unit 211 determines the detection mark set to the target to be valid.

In step S605, the determination unit 211 determines the detection mark set to the target to be invalid.

Subsequently, the determination unit 211 sequentially sets each of the second, third, and subsequently detected detection marks to a target and determines, for each of the detected marks, whether the detection mark set to the target is valid or invalid based on the corresponding detection distance. The processing of the flowchart is then ended. For example, the three detection marks 401, 402, and 403 in white, black, and the single color are determined to be valid in step S604 because the widths in the conveyance direction are 3 mm, but if the width of the dirt 411 in the conveyance direction is 1 mm, the dirt 411 is determined to be invalid in step S605.

According to this flowchart, the determination unit 211 determines that, among the plurality of detection marks detected in step S302, the dirt 411 as illustrated in FIG. 4B is invalid, so that the dirt 411 is excluded from the processing targets in the operations in step S305 and the subsequent steps in FIG. 3.

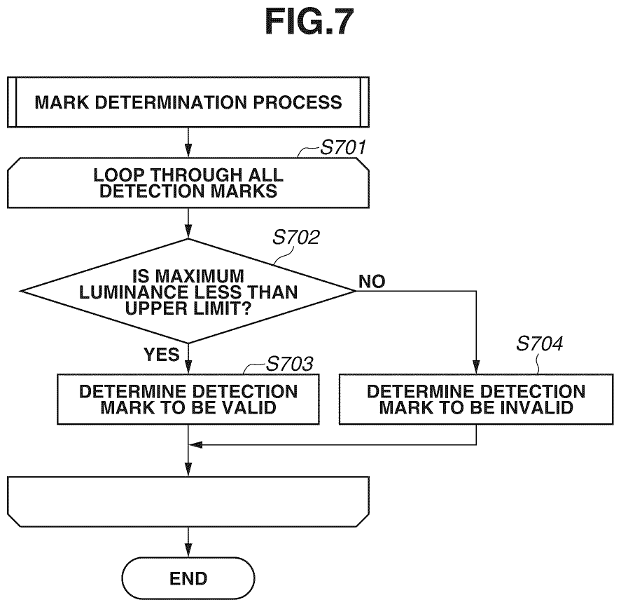

The mark determination process illustrated in FIG. 7 is a process of determining validity or invalidity of the detected detection marks based on a maximum value of the luminance of the corresponding detected detection mark.

FIG. 4C illustrates a state where external light 412 is reflected next to the single-color detection mark 403 in FIG. 4A. The external light 412 is an example of an object that causes erroneous detection as a detection mark. The external light 412 is assumed to originate from outside the image forming system 200 or from another light source, but the external light 412 is not limited to these. The luminance of the external light 412 is presumably extremely high. As illustrated in FIG. 5B, a change from the luminance 445 of the sheet base is observed at the position of external light 431 in the polyline 440, so that the detection unit 210 detects the external light 431. However, a maximum luminance value of the external light 431 is higher than a predetermined upper limit value 433. Thus, in the mark determination process illustrated in FIG. 7, any objects, such as the external light 431, with luminance higher than the upper limit value 433 are determined to be invalid.

In step S701, the determination unit 211 repeatedly executes the operations in steps S702 to S704 for the number of detection marks detected in step S302. In an example in FIG. 4C, the three detection marks 401, 402, and 403 in white, black, and the single color, respectively, and the external light 412 are to be subjected to the operations in steps S702 to S704.

In step S702, the determination unit 211 sets the first detected detection mark to a target, and obtains a maximum value of the luminance of the detection mark set to the target. The determination unit 211 then determines whether the maximum value of the luminance obtained is less than an upper limit value (e.g., 200). If the value is less than the upper limit value (YES, in step S702), the processing proceeds to step S703. If the value is greater than or equal to the upper limit value (NO, in step S702), the processing proceeds to step S704.

In step S703, the determination unit 211 determines the detection mark set to the target to be valid.

In step S704, the determination unit 211 determines the detection mark set to the target to be invalid.

Subsequently, the determination unit 211 sequentially sets each of the second, third, and subsequently detected detection marks to a target, and determines whether each detection mark is valid or invalid based on a maximum value of the luminance of the corresponding detection mark. The processing of the flowchart is then ended.

According to this flowchart, the determination unit 211 determines that the external light 412, as illustrated in FIG. 4C, is invalid among the plurality of detection marks detected in step S302, so that the external light 412 is excluded from the processing targets in the operations in step S305 and the subsequent steps in FIG. 3. The external light 412 is presumably larger in size than a detection mark. Thus, objects larger in size than a detection mark may be excluded from the targets from which the detection mark is to be selected by the selection unit 212.

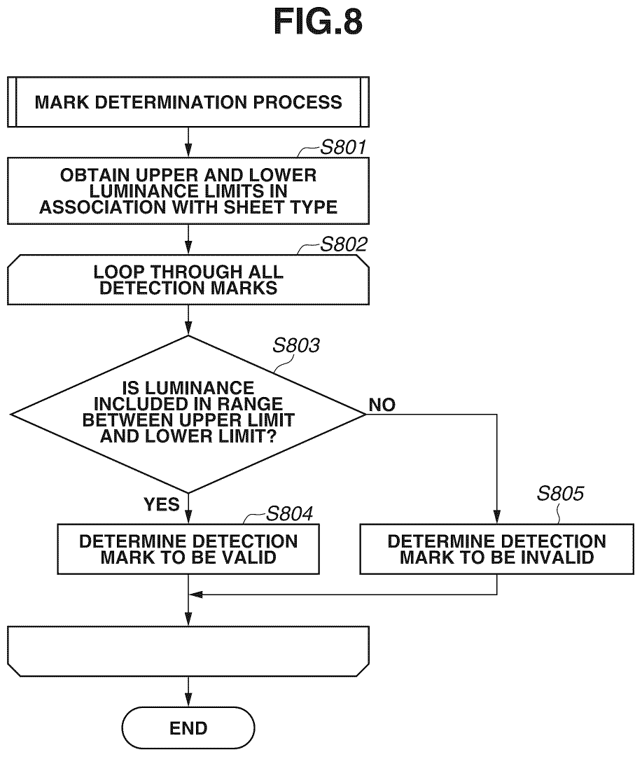

The mark determination process illustrated in FIG. 8 is a process of determining validity or invalidity of detected detection marks based on whether the luminance of the respective detection marks is within a predetermined range. Here, a special material sheet, including, but not limited to, a metallic sheet and a hologram sheet, may be used as the roll sheet 111 in addition to a high-quality sheet, and the degree of reflection of light varies depending on the type of sheet. Thus, for the luminance measured by the sensor 120, adjusting a luminance range (upper and lower limits) in which mark detection can be normally performed in accordance with the type of sheet can improve the accuracy of mark detection in some cases. In the present exemplary embodiment, a description will be provided of an example in which an upper limit value and a lower limit value are registered for each of two types of a high-quality sheet and a metallic sheet. In the present exemplary embodiment, the upper limit value of the high-quality sheet is set to 150 and the lower limit value thereof is set to 50 while the upper limit value of the metallic paper is set to 200 and the lower limit value thereof is set to 100. These values are registered in advance. The type of sheet is not limited to a high-quality sheet or a metallic sheet.

In step S801, the determination unit 211 obtains the type of sheet set in the image forming system 200, and obtains the upper limit value and the lower limit value of the luminance registered in association with the type of sheet obtained. The type of sheet may be identified from the luminance of the sheet base and obtained, or may be obtained by a user input operation on the UI displayed on the operation display unit 206. The registration information about the upper limit value and the lower limit value of the luminance for each type of sheet is stored in the storage unit 205 or the like.

Next, in step S802, the determination unit 211 repeatedly executes the operations in steps S803 to S804 for the number of detection marks detected in step S302.

In step S802, the determination unit 211 sets the first detected detection mark to a target and obtains the luminance of the detection mark set to the target.

In step S803, the determination unit 211 determines whether the luminance obtained in step S802 is included in the range between the upper limit value and the lower limit value obtained in step S801. If the luminance is within the range between the upper limit value and the lower limit value (YES in step S803), the processing proceeds to step S804. If the luminance is outside the range between the upper limit value and the lower limit value (NO in step S803), the processing proceeds to step S805.

For example, if the sheet set in the image forming system 200 is a high-quality sheet and the luminance of the white detection mark 401 is 100, the white detection mark 401 is determined to be valid in step S804. If the set sheet is then changed to a metallic sheet and the luminance of the white detection mark 401 is 100, the white detection mark 401 is determined to be valid in step S804. However, if the luminance of the black detection mark 402 is 70, the black detection mark 402 is determined to be invalid in step S805.

The present flowchart enables marks that are not suitable for use as detection marks due to their color(s) in relation to the type of sheet, among the plurality of detection marks detected in step S302, to be excluded from the processing targets in the operations in step S305 and the subsequent steps in FIG. 3.

According to the above exemplary embodiments, a plurality of marks having different colors are printed on a recording medium in advance, and a mark to be used for position detection can be selected and set from the plurality of marks based on the luminance of the respective marks. This avoids situations where a mark cannot be detected due to a small difference from the base color of a sheet, thus ensuring accurate mark detection.

According to the present disclosure, a mark formed on a recording medium can be accurately detected.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-039644, filed Mar. 14, 2024, which is hereby incorporated by reference herein in its entirety.

What is claimed is:

1. An information processing apparatus, comprising:
at least one memory that stores a set of instructions; and
at least one processor that executes the instructions causing the information processing apparatus to perform operations comprising:
detecting a plurality of marks of different colors formed on a recording medium based on a measurement result obtained by reading the recording medium being conveyed; and
selecting, from among the plurality of marks, a mark to be used for specifying a position of an image to be printed on the recording medium based on a measurement value of each of the plurality of marks.

2. The information processing apparatus according to claim 1, wherein the measurement result includes measurement values of luminance.

3. The information processing apparatus according to claim 1, wherein the mark to be used for specifying the position of the image is selected based on a luminance difference representing a difference between luminance of each of the plurality of marks and luminance of the recording media itself.

4. The information processing apparatus according to claim 3, wherein a mark having the largest luminance difference is selected as the mark to be used for specifying the position of the image from among the plurality of marks.

5. The information processing apparatus according to claim 1, wherein the plurality of marks is printed with a plurality of inks of different colors before the image is printed on the recording medium.

6. The information processing apparatus according to claim 5, wherein the plurality of inks includes white ink.

7. The information processing apparatus according to claim 1, wherein a distance of each area of the plurality of marks in a conveyance direction is obtained from the measurement result, and a mark, among the plurality of marks, of which the distance is less than a predetermined threshold or greater than a predetermined threshold is excluded from selection targets.

8. The information processing apparatus according to claim 1, wherein a maximum value of luminance of each of the plurality of marks is obtained from the measurement result, and a mark, among the plurality of marks, having the maximum value of the luminance equal to or greater than a predetermined threshold is excluded from selection targets.

9. The information processing apparatus according to claim 1,
wherein the instructions further cause the information processing apparatus to perform obtaining a luminance range in association with a sheet type of the recording medium, and
wherein a mark with luminance outside the luminance range among the plurality of marks is excluded from selection targets.

10. The information processing apparatus according to claim 1, wherein the recording medium is a continuous sheet.

11. The information processing apparatus according to claim 1, wherein the instructions further cause the information processing apparatus to perform printing the plurality of marks at positions not overlapping the image with a plurality of inks of different colors before the image is printed on the recording medium.

12. An information processing method, comprising:
detecting a plurality of marks of different colors formed on a recording medium based on a measurement result obtained by reading the recording medium being conveyed; and
selecting, from among the plurality of marks, a mark to be used for specifying a position of an image to be printed on the recording medium based on a measurement value of each of the plurality of marks.

13. A non-transitory computer-readable storage medium storing instructions that, when executed by a computer, cause the computer to perform an information processing method, the method comprising:
detecting a plurality of marks of different colors formed on a recording medium based on a measurement result obtained by reading the recording medium being conveyed; and
selecting, from among the plurality of marks, a mark to be used for specifying a position of an image to be printed on the recording medium based on a measurement value of each of the plurality of marks.
